(19) United States
(12) Patent Application Publication
(10) Pub. No.: US 2025/0030705 A1
(43) Pub. Date: Jan. 23, 2025

(54) DATA LOSS PREVENTION

(71) Applicant: VMware LLC, Palo Alto, CA (US)

(72) Inventors: SHARADENDU PRAKASH SINHA, Pune (IN); SIDDHARTH SUKUMAR BURLE, Pune (IN); MANISH JAIN, Faridabad (IN); NITIN KOTHARI, Pune (IN); SACHIN MAHAJAN, Pune (IN)

(21) Appl. No.: 18/381,702

(22) Filed: Oct. 19, 2023

(30) Foreign Application Priority Data
Jul. 21, 2023 (IN) 202341049433

(51) Int. Cl. H04L 9/40

(52) U.S. Cl. CPC H04L 63/1416

(57) ABSTRACT

Systems, apparatus, articles of manufacture, and methods are disclosed to prevent data loss, including determining a multi-layered security protocol from a plurality of security protocols stored in a database, after a determination that the multi-layered security protocol includes at least one security protocol corresponding to each unique type, causing the multi-layered security protocol to be enabled, after a breach of the multi-layered security protocol, performing an enforcement, the enforcement to include using a third-party integration and notifying a developer.

### RELATED APPLICATIONS

Benefit is claimed under 35 U.S.C. 119 (a)-(d) to Foreign application No. 202341049433 filed in India entitled “DATA LOSS PREVENTION”, on Jul. 21, 2023, by VMware, Inc., which is herein incorporated in its entirety by reference for all purposes.

### FIELD OF THE DISCLOSURE

This disclosure relates generally to cloud computing systems and, more particularly, to data loss prevention.

### BACKGROUND

In recent years, users generate data by using cloud computing systems. This data can be stolen or made public by a user error. Firewalls protect some of the data from breaches, but are insufficient for a cloud computing environment.

### BRIEF DESCRIPTION OF THE DRAWINGS

FIG. 1 is a schematic block diagram of an example environment in which example data loss prevention circuitry operates to prevent data loss in a cloud computing environment.

FIG. 2 is a block diagram of an example implementation of the data loss prevention circuitry of FIG. 1.

FIG. 3 is a flowchart representative of example machine readable instructions and/or example operations that may be executed, instantiated, and/or performed by example programmable circuitry to implement the data loss prevention circuitry of FIG. 2.

FIG. 4 is a flowchart representative of example machine readable instructions and/or example operations that may be executed, instantiated, and/or performed by example programmable circuitry to implement the data loss prevention circuitry of FIG. 2.

FIG. 5 is a flowchart representative of example machine readable instructions and/or example operations that may be executed, instantiated, and/or performed by example programmable circuitry to implement the data loss prevention circuitry of FIG. 2.

FIG. 6 is an example illustration of a multi-layered security protocol.

FIG. 7 is a block diagram of an example processing platform including programmable circuitry structured to execute, instantiate, and/or perform the example machine readable instructions and/or perform the example operations of FIGS. 3-5 to implement the data loss prevention circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine readable instructions of FIGS. 3-5) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

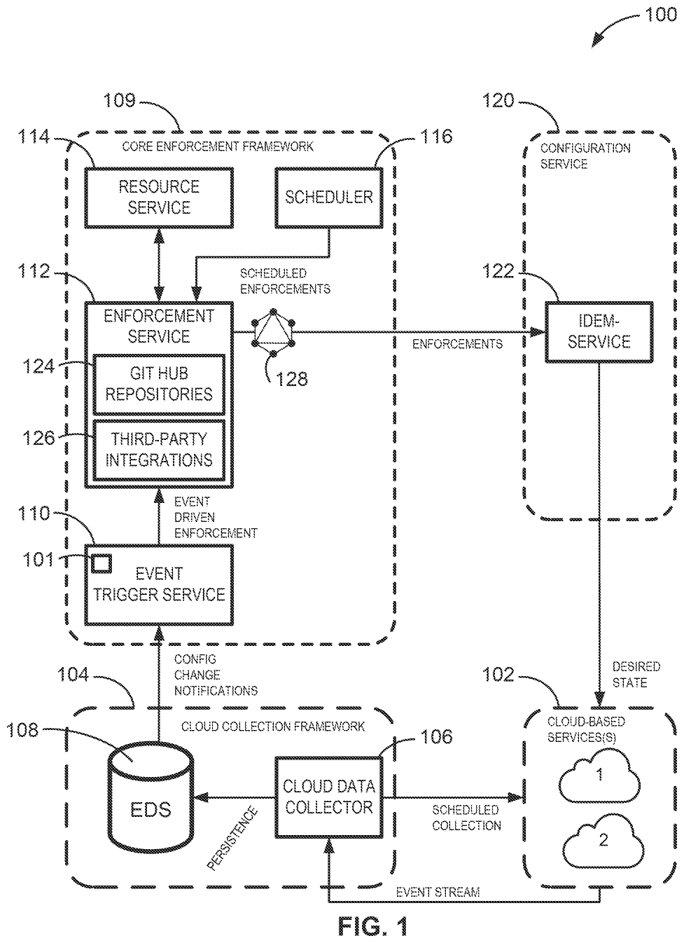

FIG. 1 is a schematic block diagram of an example environment 100 in which an example data loss prevention circuitry 101 operates to manage deployment of microservices of a distributed computing system. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 extracts, receives and/or queries information (e.g., components, metadata, services, service information) from the cloud-based service(s) 102. In this example, the cloud data collector 106 requests and/or directs the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110, an example enforcement service 112 that implements the aforementioned data loss prevention circuitry 101, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives). The example enforcement service 112 includes example GitHub repositories 124 and example third-party integrations 126. The GitHub repositories 124 store software that has been developed and/or deployed. The third-party integrations 126 are either third-party services or third-party tools that can inspect the cloud-based services 102 or perform enforcements. The example enforcement service 112 is in communication with an automated query language endpoint 128 (e.g., a GraphQL endpoint) that is in communication with the example IDEM-service 122.

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud-based service(s) 102 based on enforcements provided from the enforcement service 112. While the data loss prevention circuitry 101 is shown implemented in the example event trigger service 110, additionally or alternatively, the data loss prevention circuitry 101 can be implemented in the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

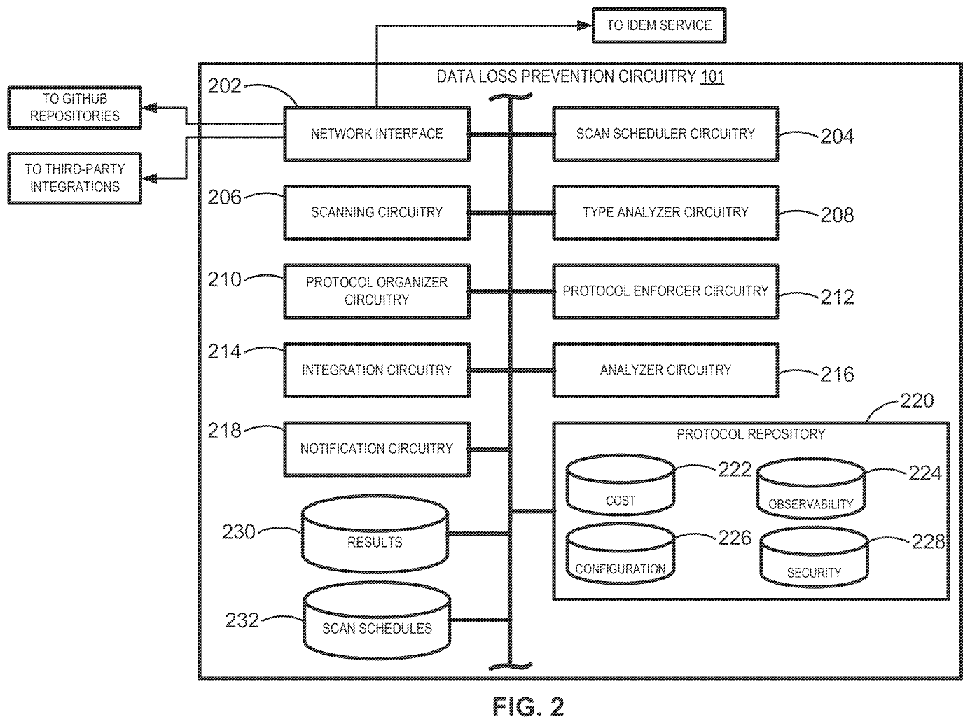

FIG. 2 is a block diagram of an example implementation of the data loss prevention circuitry 101 of FIG. 1 to prevent data loss through errors committed by the user or a breach by an unauthorized user (e.g., a hacker, a malicious user, malware). The data loss prevention circuitry 101 of FIG. 2 may be instantiated (e.g., creating an instance of, bring into being for any length of time, materialize, implement, etc.) by programmable circuitry such as a Central Processor Unit (CPU) executing first instructions. Additionally or alternatively, the data loss prevention circuitry of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The data loss prevention circuitry 101 of FIG. 2 includes an example network interface 202, example scan scheduler circuitry 204, example scanning circuitry 206, example type analyzer circuitry 208, example protocol organizer circuitry 210, example protocol enforcer circuitry 212, example integration circuitry 214, example analyzer circuitry 216, example notification circuitry 218, an example protocol repository 220, an example cost type 222, an example observability type 224, an example configuration type 226, an example security type 228, an example results database 230, and an example scan schedules database 232.

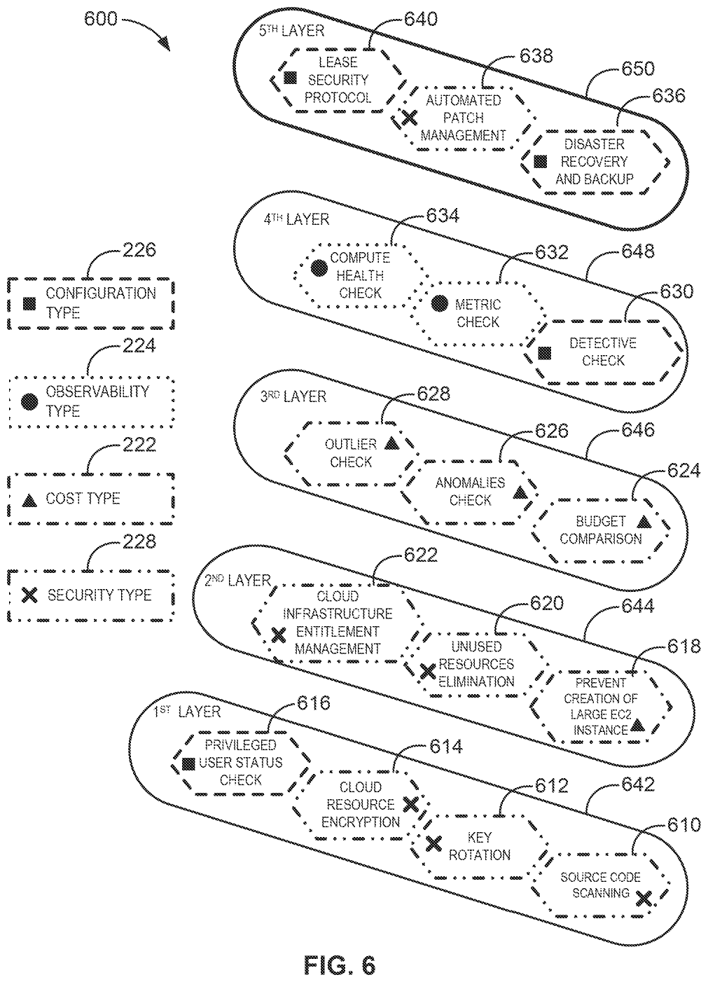

The example network interface 202 is to receive (e.g., access, retrieve) the security protocols. The example network interface 202 stores the security protocols based on the type of the security protocol into one of the databases in the protocol repository 220. For example, the network interface 202 stores the security protocols (e.g., the prevent creation of large EC2 instance security protocol 618 of FIG. 6, the budget comparison security protocol 624 of FIG. 6, the anomalies check security protocol 626 of FIG. 6, and the example outlier check security protocol 628 of FIG. 6) that belong to the cost type 222 together in an example cost type repository. The example network interface 202 stores the security protocols (e.g., the metric check security protocol 632 of FIG. 6 and the compute health check security protocol 634 of FIG. 6) that belong to the observability type 224 together in an example observability type repository. The example network interface 202 stores the security protocols (e.g., the privileged user status check security protocol 616 of FIG. 6, the detective check security protocol 630 of FIG. 6, the disaster recovery and backup security protocol 636 of FIG. 6, and the lease security protocol 640 of FIG. 6) that belong to the configuration type 226 together in an example configuration type repository. The example network interface 202 stores the security protocols (e.g., the source code scanning security protocol 610 of FIG. 6, the key rotation security protocol 612 of FIG. 6, the cloud resource encryption security protocol 614 of FIG. 6, the unused resources elimination security protocol 620 of FIG. 6, the cloud infrastructure entitlement management security protocol 622 of FIG. 6, and the automated patch management security protocol 638 of FIG. 6) that belong to the security type 228 together in an example security type repository.

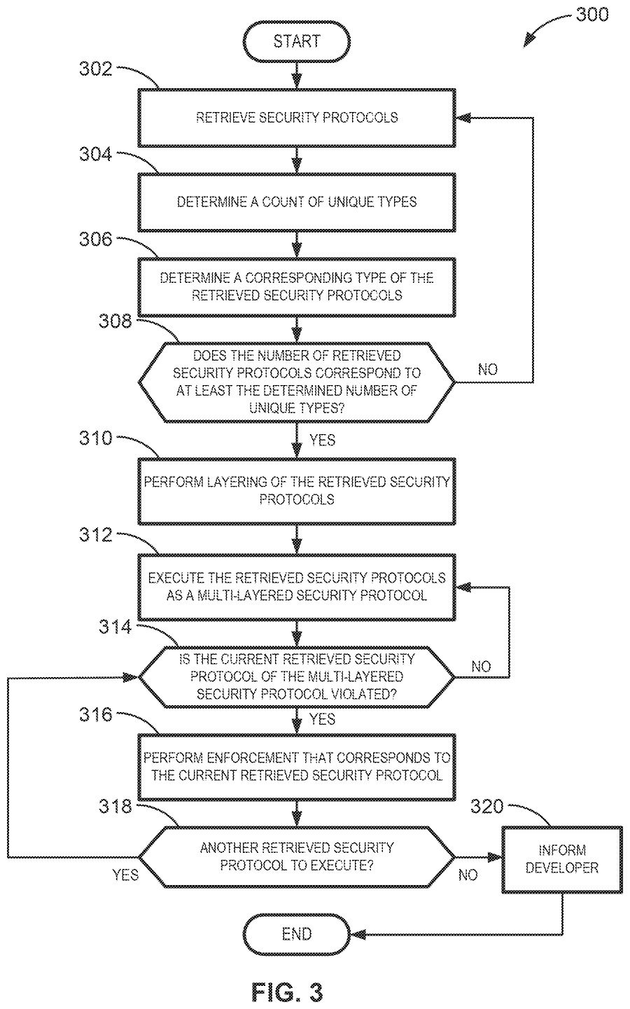

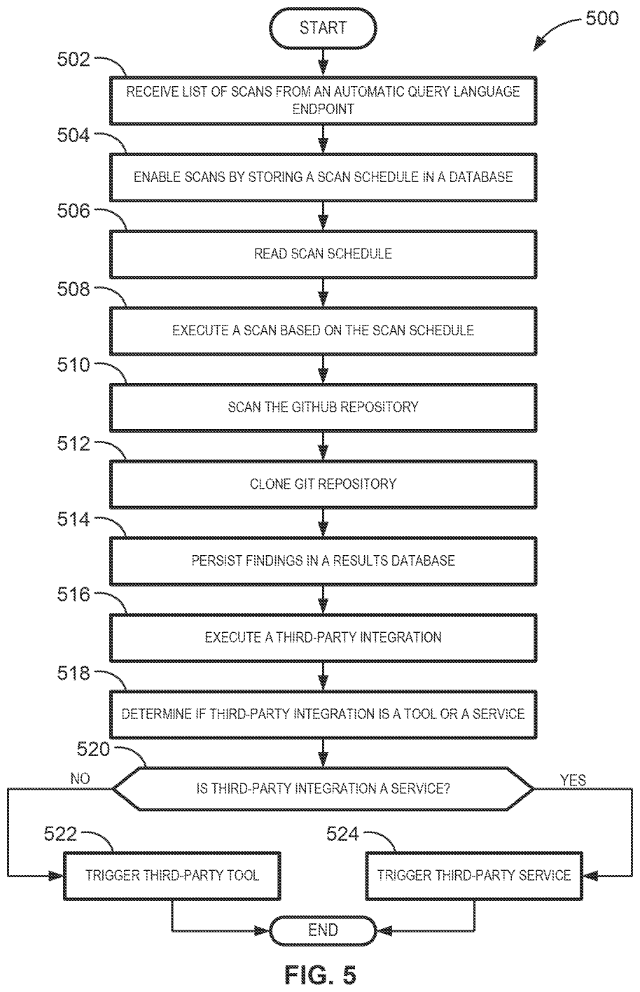

In some examples, the example network interface 202 is instantiated by programmable circuitry executing network interface instructions and/or configured to perform operations such as those represented by the flowchart(s) of FIGS. 3 and 5.

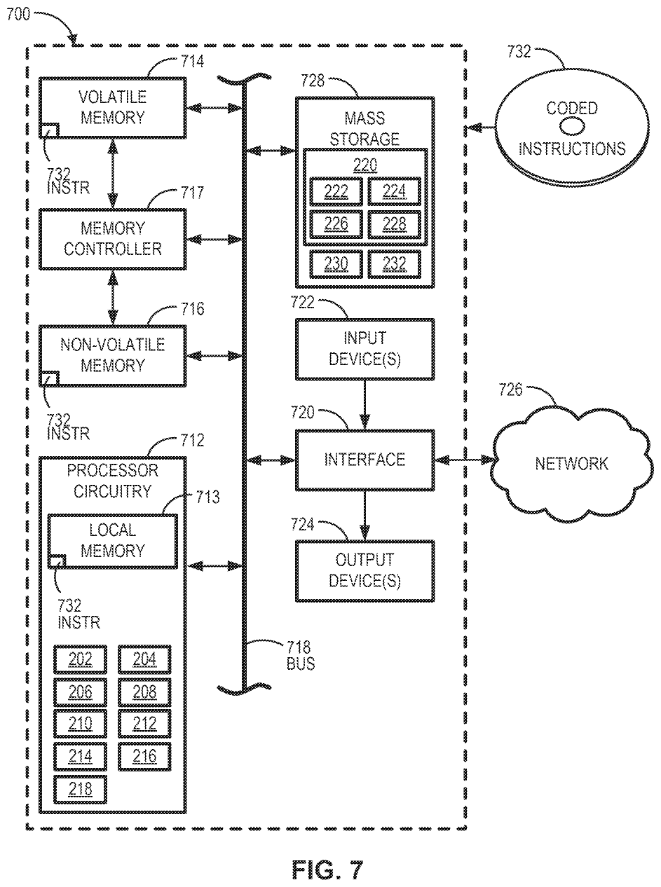

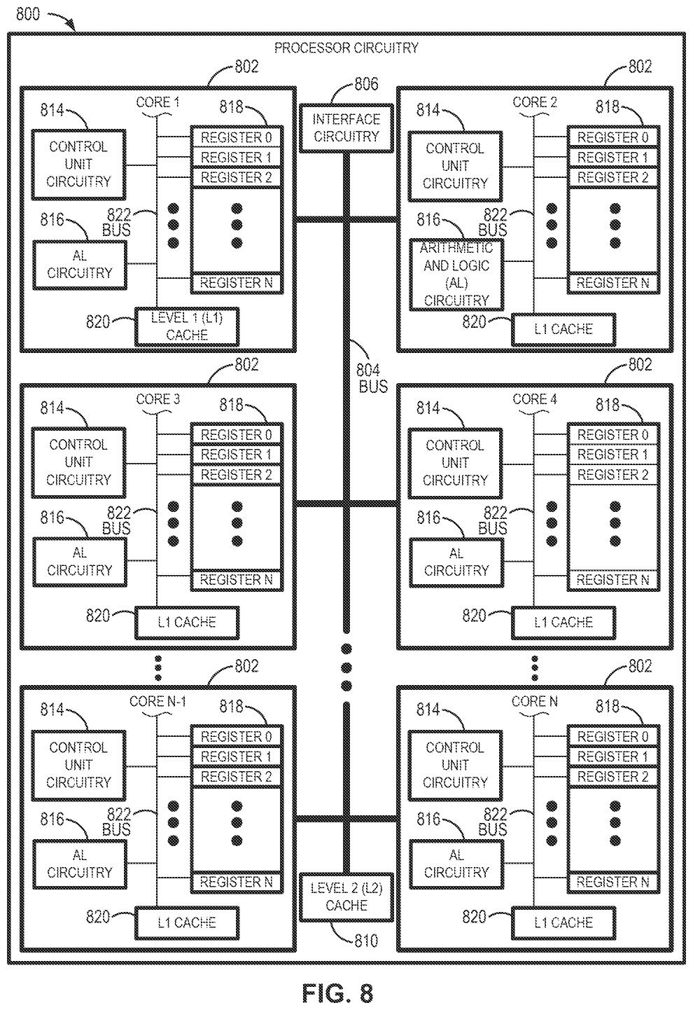

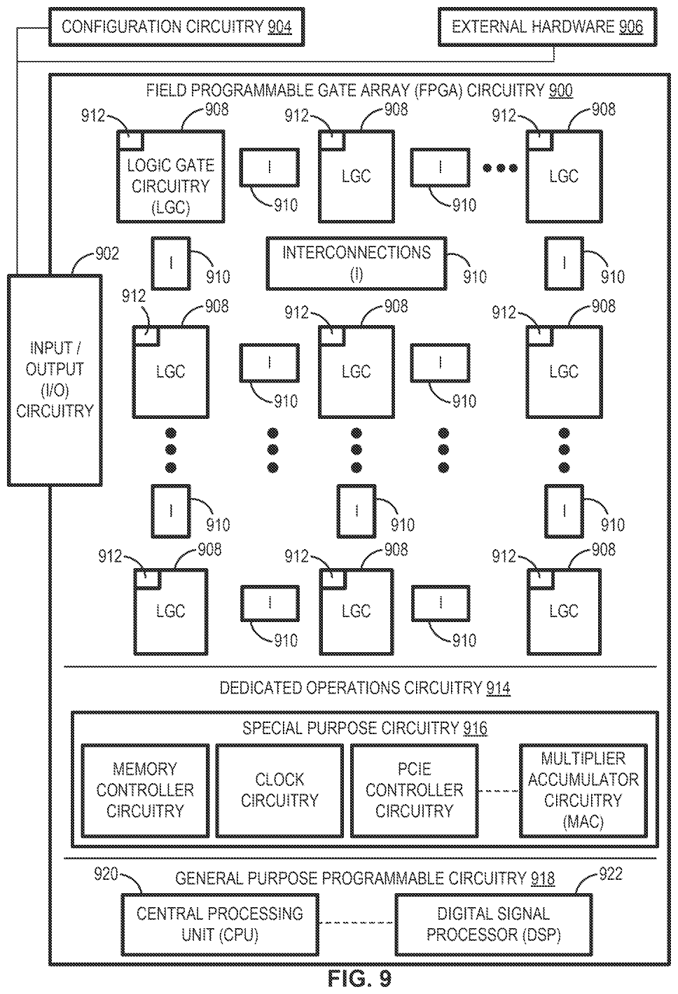

In some examples, the data loss prevention circuitry includes means for retrieving security protocols. For example, the means for retrieving security protocols may be implemented by the network interface 202. In some examples, the network interface 202 may be instantiated by programmable circuitry such as the example programmable circuitry 712 of FIG. 7. For instance, the network interface 202 may be instantiated by the example microprocessor 800 of FIG. 8 executing machine executable instructions such as those implemented by at least blocks 302 of FIG. 3 and block 502 of FIG. 5. In some examples, the network interface 202 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the network interface 202 may be instantiated by any other combination of hardware, software, and/or firmware. For example, the network interface 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example scan scheduler circuitry 204 is to determine when to instruct the scanning circuitry 206 to scan the GitHub repositories 124. For example, the scan scheduler circuitry 204 may determine that the scanning circuitry 206 is to scan the GitHub repositories 124 on a periodic basis of every ninety days. In other examples, the scan scheduler circuitry 204 determines to instruct the scanning circuitry 206 to perform a scan in response to a code deployment from a developer.

In some examples, the scan scheduler circuitry 204 is instantiated by programmable circuitry executing scan scheduler instructions and/or configured to perform operations such as those represented by the flowchart(s) of FIG. 5.

In some examples, the data loss prevention circuitry includes means for enabling scans of a code repository. For example, the means for enabling scans of a code repository may be implemented by scan scheduler circuitry 204. In some examples, the scan scheduler circuitry 204 may be instantiated by programmable circuitry such as the example programmable circuitry 712 of FIG. 7. For instance, the scan scheduler circuitry 204 may be instantiated by the example microprocessor 800 of FIG. 8 executing machine executable instructions such as those implemented by at least blocks 504 and 506 of FIG. 5. In some examples, the scan scheduler circuitry 204 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the scan scheduler circuitry 204 may be instantiated by any other combination of hardware, software, and/or firmware. For example, the scan scheduler circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example scanning circuitry 206 is to perform a scan of the GitHub repositories 124. In some examples, the scanning circuitry 206 is to clone the GitHub repositories 124 after the scan is performed. The example scanning circuitry 206 may clone the GitHub repositories 124 to save network bandwidth or to increase a cost optimization for the cloud infrastructure resources. As used herein, the scanning circuitry 206 is for scanning the source code repositories which is a security protocol that corresponds to the security type of 228. As used herein, the analyzer circuitry 216 is to scan or analyze factors that relate to cost, observability (e.g., CPU usage), and configuration (e.g., size of compute instances). The scanning circuitry 206 monitors the cloud repositories by continuously scanning the GitHub repositories 124.

In some examples, the scanning circuitry 206 is instantiated by programmable circuitry executing scanning instructions and/or configured to perform operations such as those represented by the flowchart(s) of FIGS. 3-5.

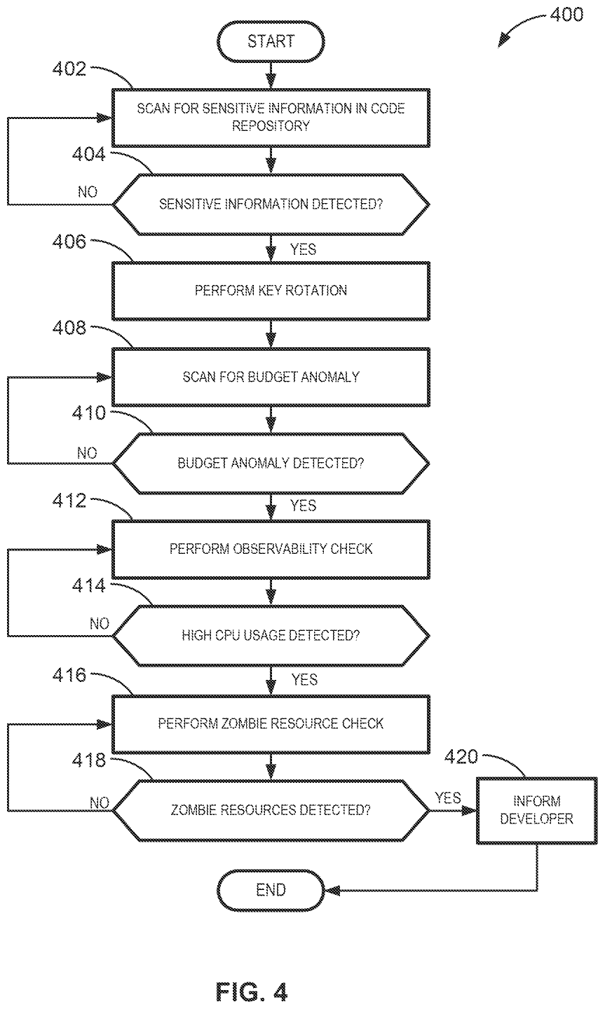

In some examples, the data loss prevention circuitry includes means for scanning. For example, the means for scanning may be implemented by scanning circuitry 206. In some examples, the scanning circuitry 206 may be instantiated by programmable circuitry such as the example programmable circuitry 712 of FIG. 7. For instance, the scanning circuitry 206 may be instantiated by the example microprocessor 800 of FIG. 8 executing machine executable instructions such as those implemented by at least blocks 402, 404, 408, 412 of FIG. 4 and blocks 508, 510, 512, 514 of FIG. 5. In some examples, the scanning circuitry 206 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the scanning circuitry 206 may be instantiated by any other combination of hardware, software, and/or firmware. For example, the scanning circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example type analyzer circuitry 208 is to determine the count of unique types for the plurality of security protocols. The example type analyzer circuitry 208 may use a similarity threshold to determine if a first security protocol is sufficiently unique from a second security protocol. The example protocol organizer circuitry 210 uses the example type analyzer circuitry 208 to determine if a first layer includes at least two security protocols that belong to a different type. The protocol organizer circuitry 210 is to form layers as a grouping of at least two individual security protocols. The multi-layered security protocol is to protect software in a development stage at an inner loop and to protect software in a deployment stage at an outer loop. The multi-layered security protocol is to include a first set of security protocols that prevent access of an unauthorized user and a second set of security protocols that detect access of the unauthorized user.

In some examples, the type analyzer circuitry 208 is instantiated by programmable circuitry executing type analyzer instructions and/or configured to perform operations such as those represented by the flowchart(s) of FIG. 3.

In some examples, the data loss prevention circuitry includes means for determining a type of a security protocol. For example, the means for determining the type of the security protocol may be implemented by type analyzer circuitry 208. In some examples, the type analyzer circuitry 208 may be instantiated by programmable circuitry such as the example programmable circuitry 712 of FIG. 7. For instance, the type analyzer circuitry 208 may be instantiated by the example microprocessor 800 of FIG. 8 executing machine executable instructions such as those implemented by at least blocks 304, 306 of FIG. 3. In some examples, the type analyzer circuitry 208 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the type analyzer circuitry 208 may be instantiated by any other combination of hardware, software, and/or firmware. For example, the type analyzer circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example protocol organizer circuitry 210 is to determine (e.g., build, construct, fashion, make, instantiate, etc.) a multi-layered security protocol from a plurality of individual security protocols that belong to different types. For example, the protocol organizer circuitry 210 determines a first layer which includes a number of security protocols that are to be executed together in parallel. In other examples, the protocol organizer circuitry 210 determines a first layer which includes a number of security protocols that are to be executed together sequentially, where a second security protocol is not executed until a first security protocol is breached. The example protocol organizer circuitry 210 determines that the first layer will have at least two security protocols that belong to different types (e.g., a first security protocol belonging to the cost type 222 and a second security protocol belonging to the observability type 224).

In some examples, the protocol organizer circuitry 210 is instantiated by programmable circuitry executing protocol organizer instructions and/or configured to perform operations such as those represented by the flowchart(s) of FIG. 3.

In some examples, the data loss prevention circuitry 101 includes means for determining a multi-layered security protocol. For example, the means for determining a multi-layered security protocol may be implemented by protocol organizer circuitry 210. In some examples, the protocol organizer circuitry 210 may be instantiated by programmable circuitry such as the example programmable circuitry 712 of FIG. 7. For instance, the protocol organizer circuitry 210 may be instantiated by the example microprocessor 800 of FIG. 8 executing machine executable instructions such as those implemented by at least blocks 308 and 310 of FIG. 3. In some examples, the protocol organizer circuitry 210 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the protocol organizer circuitry 210 may be instantiated by any other combination of hardware, software, and/or firmware. For example, the protocol organizer circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example protocol enforcer circuitry 212 performs executions in response to a determination that a security protocol has been breached. In some examples, the protocol enforcer circuitry 212 uses the example integration circuitry 214 to use a third-party integration as the enforcement. The protocol enforcer circuitry 212 is further described in connection with FIG. 4.

In some examples, the protocol enforcer circuitry 212 is instantiated by programmable circuitry executing protocol enforcer instructions and/or configured to perform operations such as those represented by the flowchart(s) of FIGS. 3-5.

In some examples, the data loss prevention circuitry 101 includes means for performing an enforcement. For example, the means for performing an enforcement may be implemented by protocol enforcer circuitry 212. In some examples, the protocol enforcer circuitry 212 may be instantiated by programmable circuitry such as the example programmable circuitry 712 of FIG. 7. For instance, the protocol enforcer circuitry 212 may be instantiated by the example microprocessor 800 of FIG. 8 executing machine executable instructions such as those implemented by at least blocks 314, 316, 218 of FIG. 3, blocks 406, 408, 412, 416 of FIG. 4, and blocks 516 of FIG. 5. In some examples, the protocol enforcer circuitry 212 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the protocol enforcer circuitry 212 may be instantiated by any other combination of hardware, software, and/or firmware. For example, the protocol enforcer circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example integration circuitry 214 is to use a third-party integration as an enforcement. For example, the integration circuitry 214 may use a first third-party integration of the third-party integrations 126 by calling a third-party service or a third-party tool. In some examples, the integration circuitry 214 receives a response from the third-party integration indicating that the security protocol was violated.

In some examples, the integration circuitry 214 is instantiated by programmable circuitry executing integration instructions and/or configured to perform operations such as those represented by the flowchart(s) of FIGS. 3-5.

In some examples, the data loss prevention circuitry 101 includes means for executing a third-party integration. For example, the means for executing a third-party integration may be implemented by integration circuitry 214. In some examples, the integration circuitry 214 may be instantiated by programmable circuitry such as the example programmable circuitry 712 of FIG. 7. For instance, the integration circuitry 214 may be instantiated by the example microprocessor 800 of FIG. 8 executing machine executable instructions such as those implemented by at least block 316 of FIG. 3, blocks 408, 412, 414, 416, 418 of FIG. 4, and blocks 516, 518, 520, 522, and 524 of FIG. 5. In some examples, the integration circuitry 214 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the integration circuitry 214 may be instantiated by any other combination of hardware, software, and/or firmware. For example, the integration circuitry 214 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example analyzer circuitry 216 is for performing analysis on cost (e.g., budgetary) anomalies, configuration anomalies, and observability anomalies. The example scanning circuitry 206 performs scans of the example code repositories. Some of the example third-party integrations 126 may be performed by the analyzer circuitry 216.

In some examples, the analyzer circuitry 216 is instantiated by programmable circuitry executing analyzer instructions and/or configured to perform operations such as those represented by the flowchart(s) of FIG. 4.

In some examples, the data loss prevention circuitry includes means for analyzing anomalies. For example, the means for analyzing anomalies may be implemented by analyzer circuitry 216. In some examples, the analyzer circuitry 216 may be instantiated by programmable circuitry such as the example programmable circuitry 712 of FIG. 7. For instance, the analyzer circuitry 216 may be instantiated by the example microprocessor 800 of FIG. 8 executing machine executable instructions such as those implemented by at least blocks 408, 410 412, 414, 416, and 418 of FIG. 4. In some examples, the analyzer circuitry 216 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the analyzer circuitry 216 may be instantiated by any other combination of hardware, software, and/or firmware. For example, the analyzer circuitry 216 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example notification circuitry 218 is to inform a developer about the status of the security protocols. The example notification circuitry 218 may alert a developer that the security protocols are breached by an unauthorized user and that a solution may be a full system reset.

In some examples, the notification circuitry 218 is instantiated by programmable circuitry executing notification instructions and/or configured to perform operations such as those represented by the flowchart(s) of FIGS. 3-4.

In some examples, the data loss prevention circuitry includes means for notifying a developer. For example, the means for notifying a developer may be implemented by notification circuitry 218. In some examples, the notification circuitry 218 may be instantiated by programmable circuitry such as the example programmable circuitry 712 of FIG. 7. For instance, the notification circuitry 218 may be instantiated by the example microprocessor 800 of FIG. 8 executing machine executable instructions such as those implemented by at least block 320 of FIG. 3 and block 420 of FIG. 4. In some examples, the notification circuitry 218 may be instantiated by hardware logic circuitry, which may be implemented by an ASIC, XPU, or the FPGA circuitry 900 of FIG. 9 configured and/or structured to perform operations corresponding to the machine readable instructions. Additionally or alternatively, the notification circuitry 218 may be instantiated by any other combination of hardware, software, and/or firmware. For example, the notification circuitry 218 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example protocol repository 220 includes security protocols that are grouped together by type. In the example of FIG. 2, the protocol repository 220 includes a cost type 222, an observability type 224, a configuration type 226, and a security type 228. The example protocol repository 220 is stored in mass storage 728 of FIG. 7.

The example results database 230 is to store the results of the scans that are executed by the scanning circuitry 206. The example results database 230 is stored in mass storage 728 of FIG. 7.

The example scan schedules database 232 is to store the scans schedules. The example scan schedules are to determine when the scanning circuitry 206 is to perform the scans. For example, the scanning circuitry 206 may perform the scans after a developer pushes the code to a public repository. In other examples, the scanning circuitry 206 performs the scans based on a period of time (e.g., every thirty days, every quarter).

While an example manner of implementing the data loss prevention circuitry 101 of FIG. 1 is illustrated in FIG. 2, one or more of the elements, processes, and/or devices illustrated in FIG. 2 may be combined, divided, re-arranged, omitted, eliminated, and/or implemented in any other way. Further, the example network interface 202, the example scan scheduler circuitry 204, the example scanning circuitry 206, the example type analyzer circuitry 208, the example protocol organizer circuitry 210, the example protocol enforcer circuitry 212, the example integration circuitry 214, the example analyzer circuitry 216, the example notification circuitry 218, and/or, more generally, the example data loss prevention circuitry of FIG. 2, may be implemented by hardware alone or by hardware in combination with software and/or firmware. Thus, for example, any of the example network interface 202, the example scan scheduler circuitry 204, the example scanning circuitry 206, the example type analyzer circuitry 208, the example protocol organizer circuitry 210, the example protocol enforcer circuitry 212, the example integration circuitry 214, the example analyzer circuitry 216, the example notification circuitry 218, and/or, more generally, the example data loss prevention circuitry, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example data loss prevention circuitry of FIG. 2 may include one or more elements, processes, and/or devices in addition to, or instead of, those illustrated in FIG. 2, and/or may include more than one of any or all of the illustrated elements, processes and devices.

Flowchart(s) representative of example machine readable instructions, which may be executed by programmable circuitry to implement and/or instantiate the data loss prevention circuitry 101 of FIG. 2 and/or representative of example operations which may be performed by programmable circuitry to implement and/or instantiate the data loss prevention circuitry 101 of FIG. 2, are shown in FIGS. 3-5. The machine readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 3-5, many other methods of implementing the example data loss prevention circuitry 101 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 3-5 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine readable instructions and/or example operations 300 that may be executed, instantiated, and/or performed by programmable circuitry to determine a multi-layered security protocol and enforce the determined multi-layered security protocol. The example machine-readable instructions and/or the example operations 300 of FIG. 3 begin at block 302, at which the example network interface 202 retrieves the security protocols. For example, the network interface 202 may retrieve the security protocols from the protocol repository 220. In some examples, the network interface 202 retrieves the security protocols from the cost type 222, the observability type 224, the configuration type 226, and the security type 228. Control advances to block 304.

At block 304, the example type analyzer circuitry 208 determines a count of unique types. For example, the example type analyzer circuitry 208 may determine a count of unique types corresponding to the protocol repository 220. In the example of FIG. 2, there are four unique types (e.g., cost type 222 (FIG. 2), the observability type 224 (FIG. 2), the configuration type 226 (FIG. 2), and the example security type 228 (FIG. 2)). Based on the count of the unique types, the type analyzer circuitry 208 notifies the protocol organizer circuitry 210 to confirm that the number of security protocols of the multi-layered security protocol 600 (FIG. 6) will match the count of unique types. Control advances to block 306.

At block 306, the example type analyzer circuitry 208 determines a corresponding type of the retrieved security protocols. For example, the example type analyzer circuitry 208 may determine that the example key rotation security protocol 612 (FIG. 6) belongs to a security type 228, while the budget comparison security protocol 624 (FIG. 6) belongs to the cost type 222. Control advances to block 308.

At block 308, the example protocol organizer circuitry 210 determines if the number of retrieved security protocols correspond to at least the determined number of unique types. For example, in response to the example protocol organizer circuitry 210 determining that the number of retrieved security protocols corresponds to at least the determined number of unique types (e.g., YES), control advances to block 310. Alternatively, in response to the example protocol organizer circuitry 210 determining that the number of retrieved security protocols does not correspond to at least the determined number of unique types (e.g., NO), control advances to block 302. In some examples, the protocol organizer circuitry 210 determines that the retrieved security protocols are equal to the number of unique types.

At block 310, the example protocol organizer circuitry 210 performs layering of the retrieved security protocols. For example, the example protocol organizer circuitry 210 may perform layering of the retrieved security protocols by organizing the security protocols into different layers. For example, the protocol organizer circuitry 210 may assign three security protocols that belong to the cost type 222 (FIG. 2) and one security protocol that belongs to the configuration type 226 (FIG. 2) to a first layer (e.g., one of the layers 642, 644, 646, 648, 650 of FIG. 6). In other examples, the protocol organizer circuitry 210 may assign a first security protocol that belongs on the security type 228, a second security protocol that belongs to the cost type 222, a third security protocol that belongs to the observability type 224, and a fourth security protocol that belongs to the configuration type 226 to a first layer (e.g., one of the layers 642, 644, 646, 648, 650 of FIG. 6). The example protocol organizer circuitry 210 also determines the ordering of the layers. For example, the protocol organizer circuitry 210 determines that the second layer 644 (FIG. 6) is to be placed before the third layer 646 (FIG. 6), because the security protocols present in the third layer 646 (FIG. 6) are able to catch certain unauthorized users that the security protocols present in the second layer 644 (FIG. 6) are unable to catch. Control advances to block 312.

At block 312, the example protocol enforcer circuitry 212 executes the retrieved security protocols as the multi-layered security protocol. For example, the protocol enforcer circuitry 212 may execute the retrieved security protocols as the multi-layered security protocol by executing the individual security protocols as layers that are designed to prevent access of unauthorized users or detect access of unauthorized users. If a first security protocol is violated, the protocol enforcer circuitry 212 executes a second security protocol. If a first layer of security protocols is violated, the protocol enforcer circuitry 212 executes a second layer of security protocols. Control advances to block 314.

At block 314, the example protocol enforcer circuitry 212 determines if the current retrieved security protocol of the multi-layered security protocol is violated. For example, in response to determining that the current retrieved security protocol (such as the source code scanning security protocol 610 of FIG. 6) of the multi-layered security protocol 600 (FIG. 6) is violated (e.g., “YES”), control advances to block 316. Alternatively, in response to determining that the current retrieved security protocol (such as the source code scanning security protocol 610 of FIG. 6) is not violated, (e.g., “NO”), control advances to block 312 to continue executing the retrieved security protocols (and the currently un-violated retrieved security protocol) as a component of the multi-layered security protocol 600 (FIG. 6).

At block 316, the example protocol enforcer circuitry 212 performs the enforcement that corresponds to the current retrieved security protocol. For example, the protocol enforcer circuitry 212 may perform a key rotation (e.g., if the source code scanning security protocol 610 of FIG. 6 is violated). If the scanning circuitry 206 (FIG. 2) performs the source code scanning security protocol 610 and discovers that the source code includes a security key in the cache, one example enforcement is performing a key rotation which will expire the security key in the cache. The example protocol enforcer circuitry 212 may perform the enforcements by using third party integrations 126 such as Amazon Macie™, GitLeaks™, and Gittyleaks™. Control advances to block 318.

At block 318, the example protocol enforcer circuitry 212 determines if there is another retrieved security protocol to execute. For example, in response to determining that there is another security protocol to execute, (e.g., “YES”), control advances to block 314. Alternatively, in response to determining that there is not another security protocol to execute, (e.g., “NO”), control advances to block 320. For example, the protocol enforcer circuitry 212 may determine if there is another security protocol by determining the number of security protocols and the number of layers of the multi-layered security protocols.

At block 320, the example notification circuitry 218 informs a developer that there are no more security protocols available. For example, the developer may perform a cloud account system reset to restore the cloud accounts back to before the unauthorized user got access to the cloud infrastructure resources. The instructions 300 end.

FIG. 4 is a flowchart representative of example machine readable instructions and/or example operations 400 that may be executed, instantiated, and/or performed by programmable circuitry to perform some of the example security protocols of the multi-layered security protocol 600 of FIG. 6. The example machine-readable instructions and/or the example operations 400 of FIG. 4 begin at block 402, at which the example scanning circuitry 206 (FIG. 2) scans for sensitive information in code repository. For example, the scanning circuitry 206 (FIG. 2) may scan for security keys in the GitHub repositories 124 (FIG. 1). Control advances to block 404.

At block 404, the example scanning circuitry 206 determines if there is sensitive information in the code repository. For example, in response to the scanning circuitry 206 detecting sensitive information in the code repository (e.g., “YES”), control advances to block 406. Alternatively, in response to the scanning circuitry 206 not detecting sensitive information in the code repository (e.g., “NO”), control advances to block 402. For example, the scanning circuitry 206 may scan for sensitive information in the version history of published cloud infrastructure workspaces. For example, a developer may use credentials for testing purposes in a software application, but deploy the software application. An unauthorized user may access the version history of the software application and find the credentials which the developer deleted from the most current version of the software application.

At block 406, the example protocol enforcer circuitry 212 performs a key rotation. For example, the protocol enforcer circuitry 212 may perform a key rotation by expiring the security keys and replacing the security keys with new security keys. Control advances to block 408.

At block 408, the example scanning circuitry 206 scans for a budget anomaly. For example, the scanning circuitry 206 may scan for a budget anomaly based on one of the security protocols that belong to the cost type 222 (FIG. 6). Control advances to block 410.

At block 410, the example scanning circuitry 206 determines if a budget anomaly is detected. For example, in response to the scanning circuitry 206 detecting a budget anomaly, (e.g., “YES”), control advances to block 412. Alternatively, in response to the scanning circuitry 206 not detecting a budget anomaly, (e.g., “NO”), control advances to block 408.

At block 412, the example protocol enforcer circuitry 212 performs an observability check such as the metric check security protocol 632 of FIG. 6. For example, if there is an increase in the cost for the suite of cloud infrastructure resources that are provisioned, the protocol enforcer circuitry 212 determines if there is also an increase in the usage (e.g., amount, size, processor cycles, CPU, GPU) of the cloud infrastructure resources. The example protocol enforcer circuitry 212 may use the example integration circuitry 214 to use one of the third-party integrations 126 such as DataDog™ to determine if there is a spike in the usage of the cloud infrastructure resources. Control advances to block 414.

At block 414, the scanning circuitry 206 determines if a high CPU usage is detected. For example, in response to the scanning circuitry 206 determining that a high CPU usage is detected (e.g., “YES”), control advances to block 416. Alternatively, in response to the scanning circuitry 206 determining that a high CPU usage is not detected (e.g., “NO”), control advances to block 412. In some examples, the integration circuitry 214 receives an indication from one of the third-party integrations 126 (FIG. 1) that scans the CPU usage if there is a high CPU usage. A high CPU usage may be a threshold that corresponds to budgetary considerations for the company that is provisioning the cloud infrastructure resources from the cloud provider.

At block 416, the example protocol enforcer circuitry 212 performs a zombie resource check. For example, the protocol enforcer circuitry 212 may perform the unused resources elimination security protocol 620 (FIG. 6) by using the scanning circuitry 206 to determine if there are zombie cloud infrastructure resources to de-provision. In some examples, the zombie cloud infrastructure resources are cloud infrastructure resources that are barely used or untagged. The example protocol enforcer circuitry 212 may use the integration circuitry 214 to use one of the third party integrations 126 (FIG. 1) to confirm the presence of zombie resources. Control advances to block 418.

At block 418, the scanning circuitry 206 determines if there are any zombie resources detected. For example, in response to the scanning circuitry 206 detecting zombie resources (e.g., “YES”), control advances to block 420. Alternatively, in response to the scanning circuitry 206 not detecting zombie resources (e.g., “NO”), control advances to block 416. In some examples, the scanning circuitry 206 is to detect the presence of zombie resources. In other examples, the integration circuitry 214 is to receive a notification from a third-party integration (e.g., a third-party tool, third-party service, etc.) if zombie resources were detected and de-provisioned.

At block 420, the example notification circuitry 218 informs a developer of the detection of budget anomalies, the detection of high CPU usage, and the detection of zombie resources. For example, the notification circuitry may transmit a secure notification to a developer (e.g., cloud administrator) of the likelihood that there is unauthorized user who has bypassed the security protocols. The developer may decide to use more security protocols or to reset the cloud system. The instructions 400 end.

FIG. 5 is a flowchart representative of example machine readable instructions and/or example operations 500 that may be executed, instantiated, and/or performed by programmable circuitry to determine a multi-layered security protocol and enforce the determined multi-layered security protocol. The example machine-readable instructions and/or the example operations 500 of FIG. 5 begin at block 502, at which the example network interface 202 receives a list of scans from an automatic query language endpoint (e.g., GraphQL™ endpoint). The example network interface 202 may receive from the automated query language endpoint 128 (FIG. 1), where the automated query language endpoint 128 (FIG. 1) received the list of scans from an IDEM runtime of the example IDEM-service 122 as an Idem data loss prevention SLS file. Control advances to block 504.

At block 504, the example scan scheduler circuitry 204 enables the scans by storing the scan schedule in a database. For example, the scan scheduler circuitry 204 may enable the scans by storing the scan schedule in a scan schedules database 232 (FIG. 2). Control advances to block 506.

At block 506, the example scan scheduler circuitry 204 reads the scan schedule. For example, the scan scheduler circuitry 204 may read the scan schedule from the scan schedules database 232 to determine a time at which scans of the repositories are to be executed. In some examples, the scan schedules may include a designation of which repositories are to be scanned by the example scanning circuitry 206. Control advances to block 508.

At block 508, the example scanning circuitry 206 executes a scan based on the scan schedule. For example, the scanning circuitry 206 may scan the repositories on a periodic basis (e.g., once a day, once a week, once an hour, etc.) or in response to a deployment of software code from a developer. Control advances to block 510.

At block 510, the example scanning circuitry 206 scans a first one of the GitHub repositories 124. For example, the scanning circuitry 206 may scan a first GitHub repository by following the source code scanning security protocol 610 (FIG. 6). Control advances to block 512.

At block 512, the example scanning circuitry 206 clones the first one of the GitHub repositories 124. For example, the scanning circuitry 206 may clone the first one of GitHub repositories 124 to save network bandwidth or to increase cost optimization. Control advances to block 514.

At block 514, the scanning circuitry 206 persists the findings in a results database. For example, the scanning circuitry 206 may determine that a security key is present in the first one of the GitHub repositories 124 and store this result in the example results database 230 (FIG. 2). Control advances to block 516.

At block 516, the integration circuitry 214 executes a third-party integration. For example, the integration circuitry 214 may execute one of the third-party integrations 126 (FIG. 1) such as Amazon Macie™, GitLeaks™, DataDog™ and Gittyleaks™. In some examples, the protocol enforcer circuitry 212 instructs the integration circuitry 214 to perform one of the third-party integrations 126 (FIG. 1) as an enforcement to one of the security protocols.

At block 518, the integration circuitry 214 determines if the third-party integration is a service or a tool. In some examples, a tool is any third-party integration that is not a service. For example, in response to the integration circuitry 214 determining that the third-party integration selected is a service (e.g. “YES”), control advances to block 524. Alternatively, in response to the integration circuitry 214 determining that the third-party integration selected is not a service (e.g., “NO”), control advances to block 522.

At block 522, the integration circuitry 214 triggers the execution of the third-party tool. For example, GitLeaks™ and GittyLeaks™ are examples of third-party tools. However, other third-party tools exist that the integration circuitry 214 may access. The instructions 500 end.

At block 524, the integration circuitry 214 triggers the execution of the third-party service. For example, Amazon Macie™ and DataDog™ are examples of a third-party service. However, other third-party services exist that the integration circuitry 214 may access. The instructions 500 end.

FIG. 6 is an example illustration of a multi-layered security protocol 600. The example multi-layered security protocol 600 is a cloud account structure that includes multiple security protocols. These security protocols are arranged by type. In the example of FIG. 6, there are four types, which include an example configuration type 226, an example observability type 224, an example cost 222, and an example security type 228 as based on the different protocol repository 220 of FIG. 2. In FIG. 6, the security protocols are arranged into layers, where typically each of the layers includes at least two security protocols with different types. In the example of FIG. 6, there are five layers including an example first layer 642, an example second layer 644, an example third layer 646, an example fourth layer 648, and an example fifth layer 650. Some of the security protocols are detective security protocols that are primarily to investigate oddities which signal the presence of an unauthorized user. Some of the security protocols are preventative security protocols that are primarily to prevent the access of the unauthorized user. In some examples, the security protocols run in parallel. In some examples, a first group of the security protocols run in parallel, while a second group of the security protocols run sequentially. In some examples, the security protocols are run sequentially.

In the example of FIG. 6, the example first layer 642 includes an example source code scanning security protocol 610, an example key rotation security protocol 612, an example cloud resource encryption security protocol 614, and an example privileged user status check security protocol 616. The example second layer 644 includes an example prevent creation of large EC2 instance security protocol 618, an example unused resources elimination security protocol 620, and an example cloud infrastructure entitlement management security protocol 622. The example third layer 646 includes an example budget comparison security protocol 624, an example anomalies check security protocol 626, and an example outlier check security protocol 628. The example fourth layer 648 includes an example detective check security protocol 630, an example metric check security protocol 632, and an example compute health check security protocol 634. The example fifth layer 650 includes an example disaster recovery and backup security protocol 636, an example automated patch management security protocol 638, and an example lease security protocol 640.

In other examples, the protocol organizer circuitry 210 (FIG. 2) determines an alternative multi-layered security protocol by organizing (e.g., building, layering, placing) the different security protocols into different ones of the layers 642, 644, 646, 648, 650 instead of the multi-layered security protocol 600 as illustrated in FIG. 6. In other examples, the example protocol organizer circuitry 210 (FIG. 2) may assign different security protocols from the protocol repository 220 (FIG. 2).

The example source code scanning security protocol 610 is described in connection with FIG. 5, as operations performed by the example scanning circuitry 206 (FIG. 2). The example scanning circuitry 206 (FIG. 2) is to scan the different GitHub repositories 124 (FIG. 1) to determine if any passwords have been exposed due to a code push by a developer. The example scanning circuitry 206 is to scan the source code according to the source code scanning security protocol 610. The example source code scanning security protocol 610 belongs to the example security type 228.

The next security protocol after the source code scanning security protocol 610 is the example key rotation security protocol 612. The example key rotation security protocol 612 is to periodically rotate security keys (e.g., API keys, access keys). In some examples, the example key rotation security protocol 612 specifies rotating the security keys a period every ninety days. In other examples, the example key rotation security protocol 612 specifies rotating the security keys once a month. The example key rotation security protocol 612 is used after the example source code scanning security protocol 610 because, if the example scanning circuitry 206 (FIG. 2) misses a security key present in the source code that is stored in the GitHub repositories 124 (FIG. 1), the security key will expire after the security keys are rotated on the time interval as specified by the example key rotation security protocol 612. The example key rotation security protocol 612 belongs to the example security type 228.

The next security protocol in the first layer 642 is the example cloud resource encryption security protocol 614. The example cloud resource encryption security protocol 614 encrypts the data (e.g., objects) which are stored in buckets (e.g., containers). Therefore, even if an unauthorized user has access to a security key that has not yet been rotated, by encrypting the data stored in the bucket, the unauthorized user will have to decrypt the data before continuing with malicious activity. The example cloud resource encryption security protocol 614 belongs to the example security type 228.

The next security protocol in the first layer 642 is the example privileged user status check security protocol 616. The example privileged user status check security protocol 616 specifies that a user requires a certain level of privileges before creating (e.g., provisioning) cloud infrastructure resources (e.g., EC2 instances). Therefore, if an unauthorized user merely has access to the encrypted filed and a security key that has not been rotated, the unauthorized user is prevented from provisioning cloud infrastructure resources without at least the minimum privilege. The example privileged user status check security protocol 616 belongs to the example configuration type 226.

The example second layer 644 includes security protocols that are enforced after the security protocols of the first layer 642 have been breached by an unauthorized user. The first security protocol in the second layer 644 is the prevent creation of large EC2 instance security protocol 618. For example, even if an unauthorized user has access to the minimum privileged status required for provisioning cloud resources, the prevent creation of large EC2 instance security protocol 618 enforces that the provisioned cloud resources will be less than the large EC2 threshold. In some examples, the large EC2 threshold may be based on the number of CPU cores (e.g., 4), the amount of RAM (e.g., 8 gigabytes of RAM), or the amount of storage (e.g., 120 gigabytes of storage). By restricting the size of the EC2 instance that can be created, the prevent creation of large EC2 instance security protocol 618 restricts the dollar amount that can be spent by the unauthorized user. In some examples, there is a correlation between the size of the EC2 instance and the cost. The example prevent creation of large EC2 instance security protocol 618 belongs to the example cost type 222.

The next security protocol in the second layer 644 is the example unused resources elimination security protocol 620. If the unauthorized user is able create a large and expensive EC2 instance, the example unused resources elimination security protocol 620 specifies that cloud resources that are not used for a threshold amount of time (e.g., ninety days, one month, etc.) will be un-provisioned. In some examples, the unused resources are called “zombie resources” or “cloud sprawls.” These unused cloud resources may also be untagged or unallocated for a specific purpose. By elimination the unused (or barely used) cloud resources, the example unused resources elimination security protocol 620 reduces the cost of the expensive EC2 by reducing the size of the large EC2 instance. The example unused resources elimination security protocol 620 belongs to the example security type 228.

The next security protocol in the second layer 644 is the example cloud infrastructure entitlement management security protocol 622. If an unauthorized user is able to prevent an unused resource from being identified as a zombie resource scheduled for elimination, the example cloud infrastructure entitlement management security protocol 622 determines if the entitlements associated with the cloud account are maintained. In some examples, the cloud infrastructure entitlement management security protocol 622 runs in parallel with the unused elimination security protocol 620. The example cloud infrastructure entitlement management security protocol 622 belongs to the example security type 228.

The example third layer 646 includes security protocols that are enforced after the security protocols of the first layer 642 and the second layer 644 have been breached by the unauthorized user. The security protocols of the example third layer 646 are all of the cost type 222. However, in other examples, the third layer 646 would include an additional security protocol that belongs to a different type than the cost type 222.

The example first security protocol in the third layer 646 is the example budget comparison security protocol 624. For example, if the unauthorized user is able to provision a large and expensive EC2 instance, the example budget comparison security protocol 624 checks a total amount spent for a period of time against a budget for that same period of time. For example, a company may determine a budget of one thousand dollars may exist to provision five EC2 instances for a month. If the company receives a bill for five thousand dollars, and compares this amount to the budgeted amount of one thousand dollars, the company may determine to check if there are any unauthorized EC2 instances which are costing the company money. In this example, the company may determine that there were large EC2 instances that were not provisioned by the employees of the company.

The next security protocol in the third layer 646 is the example anomalies check security protocol 626. If the unauthorized user is able to avoid budgetary detection, the example anomalies check security protocol 626 specifies to determine if there are patterns to the monetary spend. For example, the unauthorized user may determine the amount that has been spent lawfully (e.g., eight hundred dollars) and compare that amount to the monthly budget (e.g., one thousand dollars), and maliciously spend the difference near the end of the month (e.g., two hundred dollars). This pattern of spending would likely avoid detection by the budget comparison security protocol 624, but would likely be caught by the anomalies check security protocol 626. The example anomalies check security protocol 626 is to determine if there any unusual patterns, however the unusual patterns might not be extreme. The example outlier check security protocol 628 is to determine if there are any extreme values.

The next security protocol in the third layer 646 is the example outlier check security protocol 628. The outlier check security protocol 628 is to determine if there are any outliers, strange occurrences, and extreme values for the configuration type 226, observability type 224, and the security type 228. The example outlier check security protocol 628 is to determine if there are any extreme values from a consistent data set as based on a threshold. In some examples, an outlier is not an anomaly. The unauthorized user may be able to avoid detection based on spending a constant, consistent amount that is under the budgetary threshold by waiving a standard configuration policy. The outlier check security protocol 628 specifies to determine if any of the other policies are not being followed.

The example fourth layer 648 includes security protocols that are enforced after the security protocols of the first three layers 642, 644, 646 have been breached. The first security protocol of the example fourth layer 648 is the example detective check security protocol 630. The example detective check security protocol 630 investigates which user, with which permissions, requested the cloud resources to be provisioned and determines that the required configurations are in place. The example detective check security protocol 630 also performs the compliance checks. For example, if an unauthorized user is able to avoid detection by the outliers and the budgetary spend patterns, the detective check security protocol 630 is likely to catch the unauthorized user because an engineering manager can ask the authorized owner, if the authorized owner requested the cloud resources. The unauthorized user may be imitating the authorized owner, but the authorized owner would explain to the engineering manager who was informed by the detective check security protocol 630 that the authorized owner did not provision the cloud resources in question. The detective check security protocol 630 belongs to the configuration type 226.

The next security protocol of the example fourth layer 648 is the example metric check security protocol 632. If an unauthorized user is able to avoid detection by imitating the authorized user account and satisfying the questions of the example detective check security protocol 630, the example metric check security protocol 632 determines if there is an increase in CPU usage of a first EC2 instance which would reduce the performance of other EC2 instances. Based on the high CPU usage, as determined by the example metric check security protocol 632, an engineering manager may determine that there exists an unauthorized user who is escaping detection. The example metric check security protocol 632 belongs to the observability type 224.

The next security protocol of the example fourth layer 648 is the example compute health check security protocol 634. The example compute health check security protocol 634 determines if a cloud provider is down and that no authorized user may provision any EC2 instances, then an unauthorized user may be holding the cloud provider for ransom. In other examples, if provisioning cannot occur, because the unauthorized user provisioned too many EC2 instances, the example compute health check security protocol 634 may determine that the compute is not healthy. The example compute health check security protocol 634 belongs to the example configuration type 226.

The fifth layer 650 is the example last layer of protection for the multi-layered security protocol 600 of FIG. 6. The first security protocol of the fifth layer 650 is the example disaster recovery and backup security protocol 636. If an unauthorized user is able to avoid detection by allowing the authorized users to continue to provision EC2 instances, the example disaster recovery and backup security protocol 636 will remove the unauthorized user by returning the state of the cloud resources to a time before the unauthorized user was suspected of having access to the cloud resources. In some examples, a back-up is generated every seven days in accordance with the example disaster recovery and backup security protocol 636, so that the authorized users will only lose about the data generated in the previous week. The example disaster recovery and backup security protocol 636 belongs to the configuration type 226.

The next security protocol of the fifth layer 650 is the example automated patch management security protocol 638. For example, if the cloud platform determines that there is a security vulnerability, the security patch for the security vulnerability may be transmitted to the cloud accounts and silently updated in the background based on the example automated patch management security protocol 638. For example, the unauthorized user may be escaping detection due to an unknown security vulnerability that is discovered by the cloud platform and updated by the example automated patch management security protocol 638. The example automated patch management security protocol 638 belongs to the security type 228.

The next security protocol of the fifth layer 650 is the example lease security protocol 640. The example lease security protocol 640 specifies that the cloud resources that are provisioned by the authorized users of the company are only available for a threshold amount of time, before the company has to extend a lease for the cloud resources. After the lease is over (e.g., expired), the company will have to purchase a new lease. This reset based on the lease security protocol 640 will remove the unauthorized user. If the company of authorized users no longer has access to the cloud infrastructure resources, the unauthorized user can no longer use the company to access the cloud infrastructure resources. The lease security protocol 640 belongs to the configuration type 226.

FIG. 7 is a block diagram of an example programmable circuitry platform 700 structured to execute and/or instantiate the example machine-readable instructions and/or the example operations of FIGS. 3-5 to implement the data loss prevention circuitry 101 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a gaming console, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, DSPs, and/or microcontrollers from any desired family or manufacturer. The programmable circuitry 712 may be implemented by one or more semiconductor based (e.g., silicon based) devices. In this example, the programmable circuitry 712 implements the example network interface 202, the example scan scheduler circuitry 204, the example scanning circuitry 206, the example type analyzer circuitry 208, the example protocol organizer circuitry 210, the example protocol enforcer circuitry 212, the example integration circuitry 214, the example analyzer circuitry 216, and the example notification circuitry 218.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 732, which may be implemented by the machine readable instructions of FIGS. 3-5, may be stored in the mass storage device 728, in the volatile memory 714, in the non-volatile memory 716, and/or on at least one non-transitory computer readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 3-5 to effectively instantiate the circuitry of FIG. 2 as logic circuits to perform operations corresponding to those machine readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine readable instructions and/or operations represented by the flowcharts of FIGS. 3-5.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCle bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SIMD register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCle bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine readable instructions. However, once configured, the FPGA circuitry 900 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine readable instructions represented by the flowchart(s) of FIGS. 3-5 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 3-5. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 3-5. As such, the FPGA circuitry 900 may be configured and/or structured to effectively instantiate some or all of the operations/functions corresponding to the machine readable instructions of the flowchart(s) of FIGS. 3-5 as dedicated logic circuits to perform the operations/functions corresponding to those software instructions in a dedicated manner analogous to an ASIC. Therefore, the FPGA circuitry 900 may perform the operations/functions corresponding to the some or all of the machine readable instructions of FIGS. 3-5 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine readable instructions of FIGS. 3-5 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCle controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine readable instructions represented by the flowchart(s) of FIGS. 3-5 to perform first operation(s)/function(s), the FPGA circuitry 900 of FIG. 9 may be configured and/or structured to perform second operation(s)/function(s) corresponding to a second portion of the machine readable instructions represented by the flowcharts of FIGS. 3-5, and/or an ASIC may be configured and/or structured to perform third operation(s)/function(s) corresponding to a third portion of the machine readable instructions represented by the flowcharts of FIGS. 3-5.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

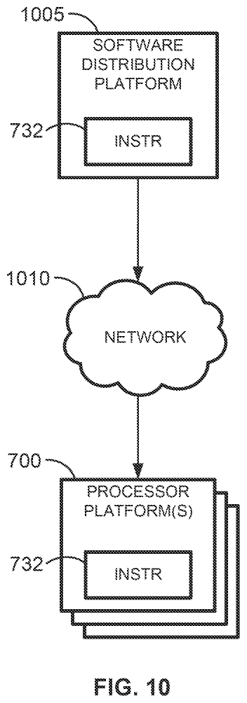

A block diagram illustrating an example software distribution platform 1005 to distribute software such as the example machine readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine readable instructions 732, which may correspond to the example machine readable instructions of FIGS. 3-5, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 732 from the software distribution platform 1005. For example, the software, which may correspond to the example machine readable instructions of FIG. 3-5, may be downloaded to the example programmable circuitry platform 700, which is to execute the machine readable instructions 732 to implement the data loss prevention circuitry 101. In some examples, one or more servers of the software distribution platform 1005 periodically offer, transmit, and/or force updates to the software (e.g., the example machine readable instructions 732 of FIG. 7) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that prevent the loss of data in a cloud environment. Disclosed systems, apparatus, articles of manufacture, and methods improve the efficiency of using a computing device by reducing the creation of cloud resources by unauthorized users. By preventing the unauthorized creation of cloud resources by unauthorized users, the processor cycles of the computing device are not wasted on tasks that, once caught by an authorized user, will be ended. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to prevent data loss are disclosed herein. Further examples and combinations thereof include the following:

Example 1 includes an apparatus comprising a network interface, instructions, protocol organizer circuitry to determine a multi-layered security protocol from a plurality of security protocols stored in a database, type analyzer circuitry to, after a determination that the multi-layered security protocol includes at least one security protocol corresponding to each unique type, cause the multi-layered security protocol to be enabled, after a breach of the multi-layered security protocol, protocol enforcer circuitry to perform an enforcement, the enforcement to include using a third-party integration, and notification circuitry to notify a developer.

Example 2 includes the apparatus of example 1, wherein the multi-layered security protocol is a cloud account structure that includes multiple security protocols of different types.

Example 3 includes the apparatus of example 1, wherein the type analyzer circuitry is to determine a count of security protocol types of the plurality of security protocols.

Example 4 includes the apparatus of example 1, further including scanning circuitry to monitor a cloud repository.

Example 5 includes the apparatus of example 4, wherein the scanning circuitry is to scan for a detection of sensitive information, budget anomalies, computer processor usage, and existence of untagged resources.

Example 6 includes the apparatus of example 5, wherein the protocol enforcer circuitry is to cause a rotation of keys, notify the developer about costs that have exceeded a threshold, notify the developer about computer processor usage that has exceeded a threshold, and delete the untagged resources.

Example 7 includes the apparatus of example 1, wherein the types are defined by a similarity threshold.

Example 8 includes the apparatus of example 1, wherein the types include a cost type, a configuration type, an observability type, and a security type.

Example 9 includes the apparatus of example 1, wherein the enforcement is a key rotation.

Example 10 includes the apparatus of example 1, wherein a first security protocol of the multi-layered security protocol is breached before a second security protocol of the multi-layered security protocol is enforced.

Example 11 includes the apparatus of example 1, wherein a layer is a grouping of at least two individual security protocols.

Example 12 includes the apparatus of example 11, wherein a first layer is to be breached before a second layer is to be enforced.

Example 13 includes the apparatus of example 12, wherein the multi-layered security protocol includes five layers and four types.

Example 14 includes the apparatus of example 1, further including scan scheduler circuitry to determine an amount of time to instantiate ones of the security protocols.

Example 15 includes the apparatus of example 1, further including an inner loop and an outer loop, the inner loop to correspond to security protocols instantiated at a software development stage.

Example 16 includes the apparatus of example 15, wherein the outer loop corresponds to security protocols instantiated at a software deployment stage.

Example 17 includes the apparatus of example 1, further including a first set of security protocols that are to prevent access of an unauthorized user.

Example 18 includes the apparatus of example 17, further including a second set of security protocols that are to detect access of the unauthorized user.

Example 19 includes a non-transitory machine readable storage medium comprising instructions to cause programmable circuitry to at least determine a multi-layered security protocol from a plurality of security protocols stored in a database, after a determination that the multi-layered security protocol includes at least one security protocol corresponding to each unique type, cause the multi-layered security protocol to be enabled, after a breach of the multi-layered security protocol, to perform an enforcement, the enforcement to include using a third-party integration, and notify a developer.

Example 20 includes the non-transitory machine readable storage medium of example 19, wherein the instructions are to cause the programmable circuitry to determine a count of security protocol types of the plurality of security protocols.

Example 21 includes the non-transitory machine readable storage medium of example 19, wherein the instructions are to cause the programmable circuitry to monitor a cloud repository.

Example 22 includes the non-transitory machine readable storage medium of example 21, wherein the instructions are to cause the programmable circuitry to scan for a detection of sensitive information, budget anomalies, computer processor usage, and existence of untagged resources.

Example 23 includes the non-transitory machine readable storage medium of example 22, wherein the instructions are to cause the programmable circuitry to cause a rotation of keys, notify the developer about costs that have exceeded a threshold, notify the developer about computer processor usage that has exceeded a threshold, and delete the untagged resources.

Example 24 includes a method comprising determining a multi-layered security protocol from a plurality of security protocols stored in a database, after a determination that the multi-layered security protocol includes at least one security protocol corresponding to each unique type, causing the multi-layered security protocol to be enabled, after a breach of the multi-layered security protocol, performing an enforcement, the enforcement to include using a third-party integration, and notifying a developer.

Example 25 includes the method of example 24, wherein the multi-layered security protocol is a cloud account structure that includes multiple security protocols of different types.

Example 26 includes the method of example 24, wherein a first security protocol of the multi-layered security protocol is breached before a second security protocol of the multi-layered security protocol is enforced.

Example 27 includes the method of example 24, wherein a layer is a grouping of at least two individual security protocols.

Example 28 includes the method of example 27, wherein a first layer is to be breached before a second layer is to be enforced.

Example 29 includes the method of example 28, wherein the multi-layered security protocol includes five layers and four types.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
a network interface;
instructions;
protocol organizer circuitry to determine a multi-layered security protocol from a plurality of security protocols stored in a database;
type analyzer circuitry to, after a determination that the multi-layered security protocol includes at least one security protocol corresponding to each unique type, cause the multi-layered security protocol to be enabled;
after a breach of the multi-layered security protocol, protocol enforcer circuitry to perform an enforcement, the enforcement to include using a third-party integration; and
notification circuitry to notify a developer.

2. The apparatus of claim 1, wherein the multi-layered security protocol is a cloud account structure that includes multiple security protocols of different types.

3. The apparatus of claim 1, wherein the type analyzer circuitry is to determine a count of security protocol types of the plurality of security protocols.

4. The apparatus of claim 1, further including scanning circuitry to monitor a cloud repository.

5. The apparatus of claim 4, wherein the scanning circuitry is to scan for a detection of sensitive information, budget anomalies, computer processor usage, and existence of untagged resources.

6. The apparatus of claim 5, wherein the protocol enforcer circuitry is to cause a rotation of keys, notify the developer about costs that have exceeded a threshold, notify the developer about computer processor usage that has exceeded a threshold, and delete the untagged resources.

7. The apparatus of claim 1, wherein the types are defined by a similarity threshold.

8. The apparatus of claim 1, wherein the types include a cost type, a configuration type, an observability type, and a security type.

9. The apparatus of claim 1, wherein the enforcement is a key rotation.

10. The apparatus of claim 1, wherein a first security protocol of the multi-layered security protocol is breached before a second security protocol of the multi-layered security protocol is enforced.

11. The apparatus of claim 1, wherein a layer is a grouping of at least two individual security protocols.

12. The apparatus of claim 11, wherein a first layer is to be breached before a second layer is to be enforced.

13. The apparatus of claim 12, wherein the multi-layered security protocol includes five layers and four types.

14. The apparatus of claim 1, further including scan scheduler circuitry to determine an amount of time to instantiate ones of the security protocols.

15. The apparatus of claim 1, further including an inner loop and an outer loop, the inner loop to correspond to security protocols instantiated at a software development stage.

16. The apparatus of claim 15, wherein the outer loop corresponds to security protocols instantiated at a software deployment stage.

17. The apparatus of claim 1, further including a first set of security protocols that are to prevent access of an unauthorized user.

18. The apparatus of claim 17, further including a second set of security protocols that are to detect access of the unauthorized user.

19. A non-transitory machine readable storage medium comprising instructions to cause programmable circuitry to at least:
determine a multi-layered security protocol from a plurality of security protocols stored in a database;
after a determination that the multi-layered security protocol includes at least one security protocol corresponding to each unique type, cause the multi-layered security protocol to be enabled;
after a breach of the multi-layered security protocol, to perform an enforcement, the enforcement to include using a third-party integration; and
notify a developer.

20. The non-transitory machine readable storage medium of claim 19, wherein the instructions are to cause the programmable circuitry to determine a count of security protocol types of the plurality of security protocols.

21. The non-transitory machine readable storage medium of claim 19, wherein the instructions are to cause the programmable circuitry to monitor a cloud repository.

22. The non-transitory machine readable storage medium of claim 21, wherein the instructions are to cause the programmable circuitry to scan for a detection of sensitive information, budget anomalies, computer processor usage, and existence of untagged resources.

23. The non-transitory machine readable storage medium of claim 22, wherein the instructions are to cause the programmable circuitry to cause a rotation of keys, notify the developer about costs that have exceeded a threshold, notify the developer about computer processor usage that has exceeded a threshold, and delete the untagged resources.

24. A method comprising:
determining a multi-layered security protocol from a plurality of security protocols stored in a database;
after a determination that the multi-layered security protocol includes at least one security protocol corresponding to each unique type, causing the multi-layered security protocol to be enabled;
after a breach of the multi-layered security protocol, performing an enforcement, the enforcement to include using a third-party integration; and
notifying a developer.

25. The method of claim 24, wherein the multi-layered security protocol is a cloud account structure that includes multiple security protocols of different types.

26. The method of claim 24, wherein a first security protocol of the multi-layered security protocol is breached before a second security protocol of the multi-layered security protocol is enforced.

27. The method of claim 24, wherein a layer is a grouping of at least two individual security protocols.

28. The method of claim 27, wherein a first layer is to be breached before a second layer is to be enforced.

29. The method of claim 28, wherein the multi-layered security protocol includes five layers and four types.
